(19) United States
(12) Patent Application Publication
(10) Pub. No.: US 2025/0315248 A1
(43) Pub. Date: Oct. 9, 2025

(54) Remote Software Updates with Storage Repartition

(71) Applicant: Hughes Network Systems, LLC, Germantown, MD (US)

(72) Inventors: Shanti Swarup Vedula, Boyds, MD (US); Mahesh Radhakrishnan, Gaithersburg, MD (US)

(21) Appl. No.: 19/240,862

(22) Filed: Jun. 17, 2025

Related U.S. Application Data
(63) Continuation-in-part of application No. 18/961,578, filed on Nov. 27, 2024.
(60) Provisional application No. 63/603,740, filed on Nov. 29, 2023.

(51) Int. Cl. G06F 8/65

(52) U.S. Cl. CPC G06F 8/65

(57) ABSTRACT

Installing critical software updates on remote devices, such as satellite terminals in inaccessible locations, poses significant challenges, especially since on-site technical support is likely unavailable. To mitigate the risk of installation failures, these devices often store backup software on a separate partition, enabling continued operation if an update fails. Embodiments detailed herein are focused on handling larger updates that require repartitioning the storage device, a process that increases risk but is necessary for accommodating large updates. These approaches are designed to ensure reliable and resilient software updates, even in remote or inhospitable environments, by maintaining system functionality and reducing the operational risks associated with failed installations.

### CROSS-REFERENCES TO RELATED APPLICATIONS

This application is a continuation-in-part of U.S. Non-Provisional patent application Ser. No. 18/961,578, filed on Nov. 27, 2024, which claims the benefit of priority to U.S. Provisional Patent Application No. 63/603,740, filed on Nov. 29, 2023, the entire contents of which is hereby incorporated by reference herein.

### BACKGROUND

In many cases, after a communication device is sold, the manufacturer provides occasional updates to the software or configuration settings of the communication device. For example, a communication device may download an update over a network (e.g., the Internet) and apply the update to improve security, add features, increase compatibility, etc. Such updates can cause complications—if the software update does not install properly or function as intended, the communication device's functionality can be negatively affected.

### SUMMARY

In some embodiments, a method for performing a software update is provided. The method can include receiving, by a communication device, from a remote server system, a request to initiate a software update. The request may indicate a required amount of storage space for an operating system. A plurality of partitions can be defined on a storage device of the communication device, and the plurality of partitions may comprise at least a first partition, a second partition, a third partition, and a fourth partition. The method may also include determining, by the communication device, that the first partition of the storage device is insufficient in size based on the required amount of storage space indicated in the request. The method can further include, in response to determining that the first partition of the storage device is insufficient in size, decreasing the size of the second partition and increasing the size of the first partition. The method may include redefining the third partition as a factory partition such that only the third partition is trusted and available for booting. The method can also include, after redefining the third partition as the factory partition, downloading, by the communication device, from the remote server system, the software update to the first partition. The method may further include, after downloading the software update, redefining the first partition as the factory partition such that only the first partition is trusted and available for booting.

Embodiments of such a method may include one or more of the following features, which may be separately combined with the method detailed above. The method can further comprise, after redefining the first partition as the factory partition, decreasing the size of the fourth partition and increasing the size of the third partition. The method may also include downloading, by the communication device, from the remote server system, the software update to the third partition. Prior to decreasing the size of the fourth partition, data may be copied from the fourth partition to the second partition. After decreasing the size of the fourth partition, the data can be copied from the second partition to the fourth partition. The method may also include, after downloading the software update to the third partition, redefining a boot trust parameter for the communication device to define a temporary level of trust for booting to the third partition and defining factory in the first partition to serve as a backup for booting if booting to the third partition fails or the communication device is rebooted due to failure to communicate with the remote server. After redefining the boot trust parameter for the communication device to define a temporary level of trust for booting to the third partition, the communication device can be rebooted. In response to booting successfully, the boot trust parameter for the communication device may be redefined to define a permanent level of trust for booting to the third partition and successfully communicating with the remote server. The communication device can communicate with the remote server system via satellite. When determining whether the first partition of the storage device is at least as large as the required amount of storage space, the first partition can be defined as the factory partition. When redefining the third partition as the factory partition, such that only the third partition is available for booting, the first partition may no longer be defined as the factory partition. Determining that the first partition of the storage device is at least as large as the required amount of storage space may comprise analyzing a board support package (BSP) manifest.

In some embodiments, a communication device is provided. The communication device can comprise one or more processors and one or more machine-readable media storing instructions that are operable, when executed by the one or more processors, to cause the communication device to perform operations. The operations may include receiving, from a remote server system, a request to initiate a software update. The request can indicate a required amount of storage space for an operating system. A plurality of partitions may be defined on a storage device of the communication device, and the plurality of partitions can comprise at least a first partition, a second partition, a third partition, and a fourth partition. The operations can also include determining that the first partition of the storage device is insufficient in size based on the required amount of storage space indicated in the request. In response to determining that the first partition of the storage device is insufficient in size, the operations may include decreasing the size of the second partition and increasing the size of the first partition. The operations can further include redefining the third partition as a factory partition such that only the third partition is trusted and available for booting. After redefining the third partition as the factory partition, the operations may include downloading, from the remote server system, the software update to the first partition. The operations can also include, after downloading the software update, redefining the first partition as the factory partition such that only the first partition is trusted and available for booting.

Embodiments of such a device may include one or more of the following features, which may be separately combined with the device detailed above. The operations may further comprise, after redefining the first partition as the factory partition, decreasing the size of the fourth partition and increasing the size of the third partition, and downloading, from the remote server system, the software update to the third partition. The operations can also include, prior to decreasing the size of the fourth partition, copying data from the fourth partition to the second partition. After decreasing the size of the fourth partition, the operations may include copying the data from the second partition to the fourth partition. The operations may further include, after downloading the software update to the third partition, redefining a boot trust parameter for the communication device to define a temporary level of trust for booting to the third partition and defining factory in the first partition to serve as a backup for booting if booting to the third partition fails or the communication device is rebooted due to failure to communicate with the remote server. After redefining the boot trust parameter to define a temporary level of trust, the operations can include rebooting the communication device. In response to booting successfully, the operations may include redefining the boot trust parameter for the communication device to define a permanent level of trust for booting to the third partition and successfully communicating with the remote server. The communication device may communicate with the remote server system via satellite. When determining whether the first partition of the storage device is at least as large as the required amount of storage space, the first partition can be defined as the factory partition. When redefining the third partition as the factory partition, such that only the third partition is available for booting, the first partition may no longer be defined as the factory partition. Determining that the first partition of the storage device is at least as large as the required amount of storage space may comprise analyzing a board support package (BSP) manifest.

In some embodiments, a non-transitory processor-readable medium is provided. The medium can comprise processor-readable instructions configured to cause one or more processors of a communication device to receive a request to initiate a software update. The request may indicate a required amount of storage space for an operating system. A plurality of partitions can be defined on a storage device of the communication device, where the partitions comprise at least a first partition, a second partition, a third partition, and a fourth partition. The instructions may also cause the one or more processors to determine that the first partition of the storage device is insufficient in size based on the required amount of storage space indicated in the request. The instructions can further cause the one or more processors, in response to determining that the first partition of the storage device is insufficient in size, to decrease the size of the second partition and increasing the size of the first partition. The instructions may cause the one or more processors to redefine the third partition as a factory partition such that only the third partition is trusted and available for booting. The instructions can also cause the one or more processors to, after redefining the third partition as the factory partition, download from a remote server system the software update to the first partition. The instructions may further cause the one or more processors to, after downloading the software update, redefine the first partition as the factory partition such that only the first partition is trusted and available for booting.

Embodiments of such a non-transitory processor-readable medium may include instructions to cause the one or more processors to perform one or more of the following features, which may be separately combined with the features detailed above. The instructions can further cause the one or more processors to, after redefining the first partition as the factory partition, decrease the size of the fourth partition and increasing the size of the third partition, and download, from the remote server system, the software update to the third partition. The instructions may also cause the one or more processors to, prior to decreasing the size of the fourth partition, copy data from the fourth partition to the second partition, and after decreasing the size of the fourth partition, copy the data from the second partition to the fourth partition. The instructions can also cause the one or more processors to, after downloading the software update to the third partition, redefine a boot trust parameter for the communication device to define a temporary level of trust for booting to the third partition and defining factory in the first partition to serve as a backup for booting if booting to the third partition fails or the communication device is rebooted due to failure to communicate with the remote server.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label, irrespective of the second reference label.

FIGS. 1A-1D illustrate embodiments of a system for updating software and configuration of a device.

FIG. 2 is a state diagram showing state transitions based on levels of trust of a main software version.

FIG. 3 is a diagram showing an embodiment of a device storage partitions layout for managing software and configurations of a device.

FIG. 4 illustrates an embodiment of adjustment of storage partitions of a communication device for which a software update is to be performed.

FIG. 5 illustrates an embodiment of further adjustment of the storage partitions of the communication device, for which the software update is to be performed.

FIG. 6 illustrates an embodiment of further adjustment of the storage partitions of the communication device, for which the software update is performed.

FIGS. 7A and 7B illustrate an embodiment of a method for performing a software update, involving a repartition of the storage device.

### DETAILED DESCRIPTION

In the installation of critical software (e.g., an update to a device's operating system or application software), an update presents significant concerns. These concerns are further magnified if the device is located in a remote location and is not easily accessible by a technician that can troubleshoot any problems that may occur during the update. As an example, a satellite terminal (which communicates with remote systems via satellite communication) may be located in an inhospitable location, a great distance from any person equipped to perform an update. As such, such an update may be performed via satellite, without a technician on-site. However, in anticipation of a problem with the installation of the software, the device can store backup software as a fallback, in order to be able to boot and function if an installation fails.

Embodiments detailed herein are focused on two major categories of software updates. First, some updates (e.g., an operating system package) may not require any changes to the partitions of a storage device that host the software. In such embodiments, as detailed herein, one partition may be updated to store and load updated software. One or more other partitions can be used as a backup or factory partition, to be used if an installation fails. Second, some updates are large enough in size that a partition available for the update is not sufficient in storage space. To complete such an update, multiple partitions of the storage device may need to be repartitioned in preparation to permit the installation to complete. Additional caution must be exercised in such installations because repartitioning a storage device can potentially increase the chance of a problem occurring during installation. Arrangements detailed herein help mitigate such problems and allow for critical software to be updated, such as in a remote environment, where the update is delivered via satellite communication.

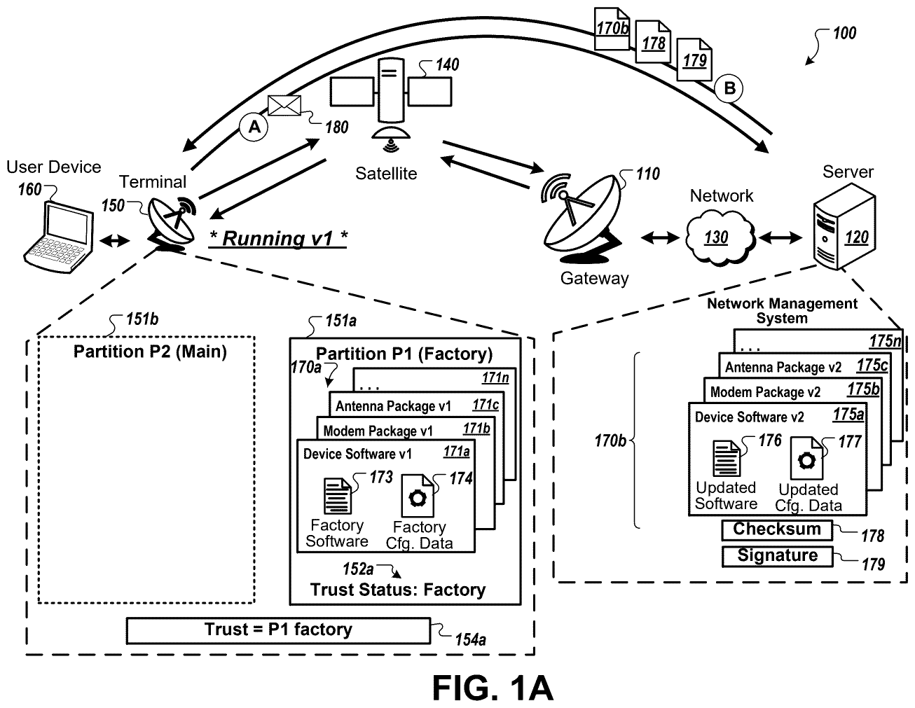

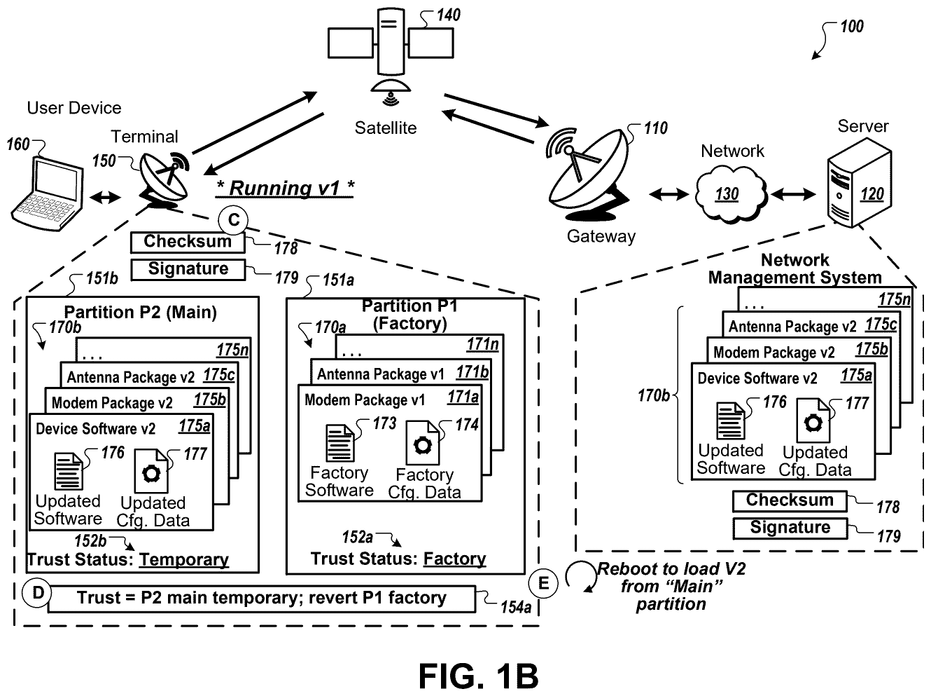

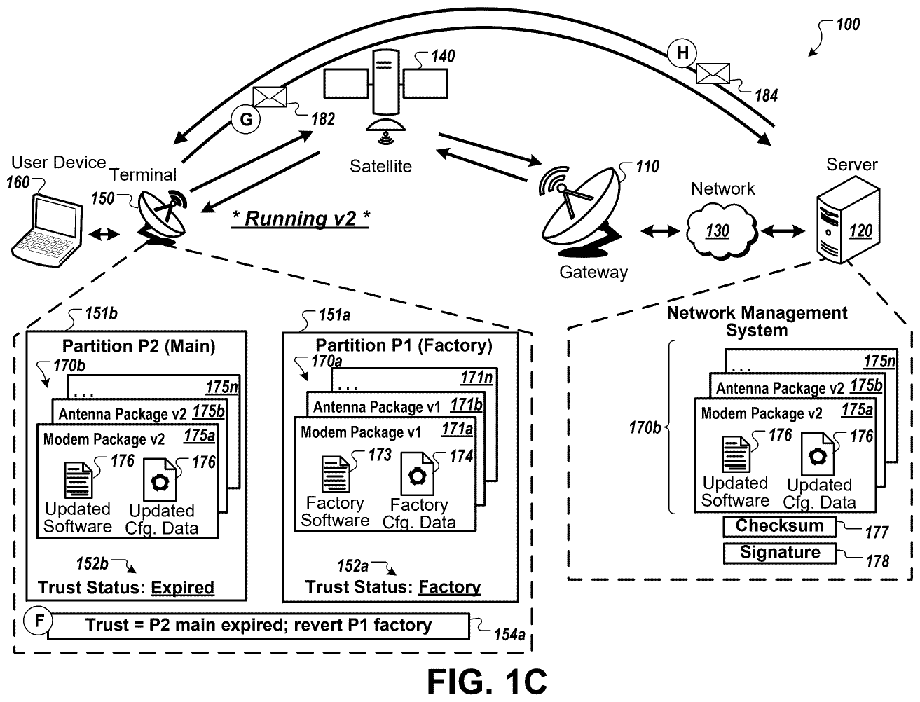

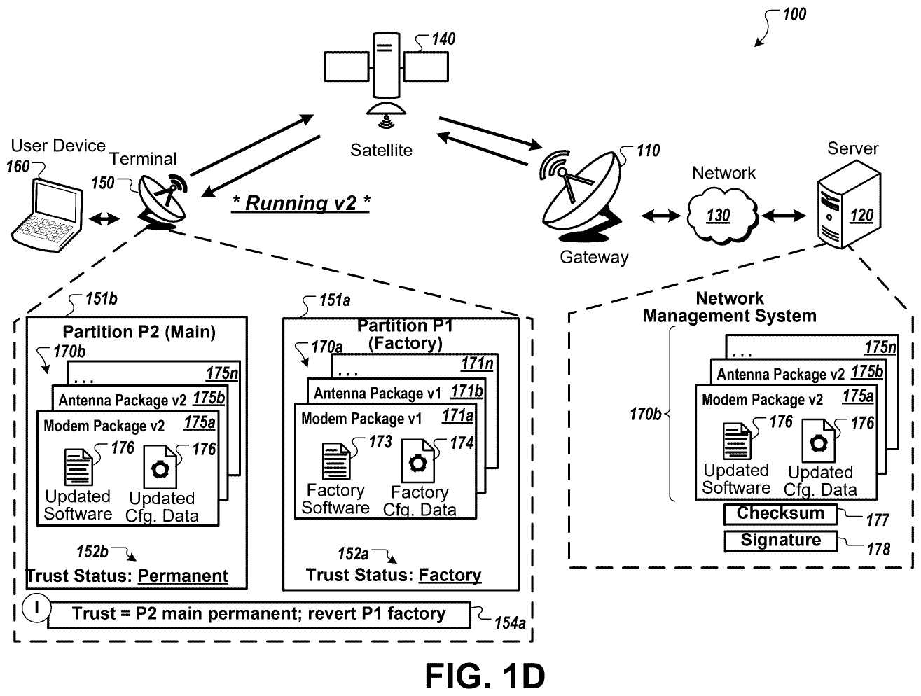

FIGS. 1A-1D are diagrams showing an example of a system 100 for updating software and configuration of a device. The example shows how software for a satellite terminal 150 can be updated, but the same techniques can be used to manage and update many other types of devices (e.g., modem, router, computer, phone, satellite gateway, etc.). In the examples, the terminal 150 starts by running an initial factory version of software and configuration data, then receives updated software (FIG. 1A). The terminal 150 then applies the software update with a limited trust status, e.g., “temporary” trust to allow limited amount of use (FIG. 1B). When the terminal 150 restarts, the new updated software is used but the trust status is downgraded (e.g., to an “expired” state), so continued use of the new software after the next restart requires verification that the terminal 150 operates correctly with the new software (FIG. 1C). Once the verification is performed successfully, and the proper operation of the terminal 150 is confirmed, then the trust in the new software is upgraded (e.g., to “permanent” or high trust) so the software update is used going forward, including after device restarts (FIG. 1D). By contrast, if the terminal 150 does not confirm proper operation after a software update, then the terminal 150 would automatically revert to using the previous working version of the software so proper operation is restored.

The system 100 shows an example of a user device 160 that obtains network connectivity through a satellite connection provided by the satellite terminal 150. The user device 160 is connected to the satellite terminal 150 (e.g., through a local connection), and the terminal 150 communicates with a satellite 140 that is also in communication with a terrestrial satellite gateway 110. The connection from the terminal 150 to the gateway 110 via the satellite 140 provides the network connection to a ground-base network 130, such as the Internet, so the user device 160 can communicate with various other servers and devices.

The system 100 also includes a server 120, which can operate as a network operations center (NOC) or network management system, which can store and provide software updates for satellite terminals or other devices. The terminal 150 can be configured to periodically check for updates through communication with the server 120, and when an update is available, the terminal 150 receives the update over the network connection.

The terminal 150 can be configured to allocate multiple logical data storage areas (such as partitions, file system folders, etc.) for storing different versions of software or other configuration information. This can allow the terminal 150 to preserve multiple versions of software to permit restoration to a factory version in the event of an error, and/or to permit a new software version to be installed and tested without overwriting the previous version of the software.

Managed embedded devices such as satellite terminals, routers, gateways, Internet-of-things (IOT) devices, etc., typically maintain two versions of software and configuration data, such as a “factory” version loaded initially when shipped from the factory, and a “main” version that is the most recent, e.g., the “latest and greatest” version with new features and bug fixes downloaded from the network. Typically, if the user needs to recover the device in the event of a malfunction, the user switches to the factory version by pressing a “rescue” or “reset” button at the back of the device or through a locally executed command. For this reason, since the factory version is often the last ‘lifeline’ the user has in order to restore proper operation, the factory version is often left untouched, e.g., not updated unless absolutely required. Since many devices are often located in remote areas, it becomes very important to not only make sure only compatible software is downloaded and installed, but also provide a recovery mechanism in the event of an upgrade failure. The potential failures go beyond issues such as image corruption (e.g., a corrupted copy of the software being received) and include cases such as interruption of power during the upgrade process or incompatibility or flaw in the upgrade itself preventing the device from becoming operational.

Furthermore, over time, the factory version may become too old and out of date to operate well in combination with other software on the device. As a result, switching to the factory partition may potentially cause problems, such as: (1) a mismatch in configuration, in which the older factory software does not recognize some newer advanced configuration parameters; (2) security loopholes, such as a when a password change in the main partition does not carry over to the factory partition; or (3) incompatibility among versions of component software, such as modem software that is no longer compatible with the older version in the factory partition. The terminal 150 can include features to upgrade software and manage versions based on operational trust, which can be used to reliably recover from operational failures that might occur due to a newly installed software, as well as to reliably upgrade an outdated factory version in the field remotely.

In the example of FIGS. 1A-1D, the terminal 150 has multiple partitions 151a-151b for storing software and configuration data. The first partition “P1” 151a stores a factory version of software, which is labeled as version “v1” of the software. The partition has been designated as a factory version, which typically involves specific certification or qualification by the device manufacturer to reach this status. The factory version is stored and kept available in case the device needs to be recovered or reverted to its factory state.

The terminal 150 has another partition “P2” 151b that is initially empty. The second partition P2 151b is available to store a “main” version of the software, e.g., an upgraded version that will be used to boot the device, but no upgraded version has been received.

The terminal 150 is configured to use trust ratings or trust status indicators to determine which partition 151a-151b to use when booting or starting the terminal 150. For example, if there are multiple versions of software, the terminal 150 can use the trust status indicators to select which version of the software to load and run. In the example, the partition P1 151a has a trust status 152a that indicates high trust, such as the status of “permanent” indicating that the partition P1 151a should be used as the primary version each time the terminal 150 is booted. By contrast, the Partition P2 151b can have a trust status 152b that indicates no trust, such as the status of “expired” or no trust indicator at all, indicating that the partition P2 151b should not be used at all to boot or start the terminal 150. The trust properties for partitions 151a-151b for booting the device can be defined in a set of trust parameters 154a, which indicates that the trust state is “P1 factory,” indicating that the terminal 150 should boot from the P1 partition 151a with the “factory” indication indicating high trust (e.g., permanent, unconstrained, or unlimited) use, allowing for repeated use. Typically, the high level of certification of factory version of the software permits very high trust in factory versions.

The software in the partition can include multiple components. In Linux-based devices, software updates also include updates to the operating system, file system, and device binaries, possibly across multiple storage partitions or mounts. Some devices such as satellite terminals can have multiple components (such as a modem, an antenna, or other subsystems or hardware modules) that each have its own software and configuration settings, in addition to the overall device software (e.g., boot software or operating system). In these cases, a software “bundle” including a software package for each device component, along with the corresponding configuration settings, can be qualified together to make sure the software and settings for the various components function correctly together and are compatible with each other. As a result, it should typically not cause any issues for the device to switch from using one partition to another, as each partition is self-contained with the software and configuration.

In the example, the first version “v1” of the software 170a includes several different software packages 171a-171n. The first package 171a represents overall device software, such as the operating system and other core software components. The package 171a includes the v1 factory software 173 as well as v1 factory configuration data 174. In addition, there are also software packages included for other components or subsystems of the terminal 150. For example, a v1 modem package 171b is included, as well as a v1 antenna package 171c, each of which includes its own set of software and corresponding configuration data.

The terminal 150 can be configured to periodically check with the server 120 to determine whether updated software is available. Alternatively, the server 120 can notify the terminal 150 to check if an update is available. If an updated version is available, then the terminal 150 can receive a copy over the network, test the operation of the new version, and assign an appropriate level of trust if the test of operation is successful. If the test of operation is not successful, the terminal 150 automatically reverts to using a prior version of the software that operates properly. An example of these techniques is shown through FIGS. 1A-1D through a series of operations (A) to (I), which represent a flow of data and various operations performed in the system 100.

In stage (A), the terminal 150 sends a message 180 to the server 120 to request updated software. For example, through interaction with the server 120 over the network, the terminal 150 can determine that a new version of the software is available and can request the new version.

Initially, the terminal 150 is running a factory version 170a of the software. Even after an updated version is received, the factory version 170a is retained. In some implementations, the purpose of the factory version of the software is to ensure that the terminal 150 can establish communication with the server 120 in the Network Management System (NMS) in the Network Operations Center (NOC) and download the main version of the software and configuration.

In stage (B), the terminal receives updated software 170b over the network (e.g., through the network 130 and the satellite communication link over the satellite 140). The updated software 170b includes updated software packages 175a-175n labeled version “v2” for the terminal 150 as a whole (e.g., the operating system, etc.), as well as for various components or subsystems. For example, the updated software 170b includes v2 device software, which includes updated software 176 and updated configuration data 177. Similarly, the v2 modem package 175a, the v2 antenna package 175c, and the other packages can each include different software packages and configuration data. The updated software 170b can include a checksum 178 or hash for verifying correct transmission, as well as a signature 179 to verify authenticity of the update.

Referring to FIG. 1B, in stage (C), the terminal 150, while still running the original v1 software, stores the updated software 170b in the partition P2 151b. When the terminal 150 receives the update software 170b, the terminal 150 can perform a checksum check and a signature check to verify the correctness and authenticity of the new software. While the checksum and signature checks verify the integrity and authenticity of the new software image, the real confirmation that the downloaded software and configuration operates properly is when the device, at the very least, can run the updated software 170b and reestablish contact with the server 120 after the software upgrade.

In stage (D), the trust parameters 154a are set, including a trust status 152b for the partition 151b with the newly-received updated software 170b. To reflect that the updated software 170b has not yet been verified to operate properly, the trust status 152b for the partition P2 151b containing the updated software 170b is set to be a level of low trust, e.g., temporary trust. This indicates that the software in the partition 151b can be run, but subject to one or more limitations. For example, the terminal 150 can be configured to run the software in a partition with temporary trust for a limited number of device starts or for a limited amount of time. In the example, the terminal 150 is configured to run software with a temporary trust level only once based on the temporary trust level. If the operation of the terminal 150 during that one use achieves the criteria for successful operation (e.g., if communication is established with the server 120), then the trust level can be elevated to a high or permanent level, e.g., for repeated or unrestricted use.

In the example, the trust parameters 154a indicate “P2 main temporary; revert P2 factory.” This specifies the order of partitions to boot during the next restart of the terminal 150. After the terminal 150 is restarted, the terminal 150 will boot from the partition P2 151b as the “main” or current version, but will only do so once due to the temporary trust status. If the proper operation of the updated software 170b is not verified before the next restart of the terminal 150, then the terminal 150 will automatically revert to booting from the partition P1 151a, which has a factory designation.

In stage (E), after storing the updated software 170b in the partition P2 151b and setting the trust parameters 154a, the terminal 150 reboots to cause the updated software 170b from the partition P2 151b to be run.

Referring to FIG. 1C, in stage (F), the terminal 150, now having booted using the software 170b in the partition P2 151b (e.g., running version v2), automatically updates the trust parameters 154a to adjust the trust level for the partition P2 151b. The level of trust previously was “temporary,” which allowed one boot. Now that the terminal 150 has booted with the partition P2 151b and the limited single boot has been used, the trust status is updated from “temporary” to “expired” to indicate that the partition P2 151b can no longer be used to boot upon next reboot of the terminal 150. In other words, the limitation on the allowable number of boots for the partition P2 151b has been reached and so further boots will be disallowed, unless the test of operation proves to be successful.

In stage (G), the terminal 150 (while running the v2 update software 170b from the partition P2 151b) tests its operation to verify if it is functioning properly. This can include the terminal 150 attempting to perform a predetermined set of operations and verifying that a predetermined outcome or predetermined criteria for success are achieved. For example, the terminal 150 can be configured to send a request 182 to the server 120 over the network (e.g., the satellite connection and the network 130) to elicit a response from the server 120 that can confirm that the communication functions of the terminal 150 are operating as expected with the new software and configuration.

In the case of the terminal 150, establishing communication over a network is a core or fundamental operation for the terminal 150, and is one that requires most if not all of the subsystems of the terminal 150 to be used and to operate properly. The set of operations attempted or the set of tests performed can be selected to test some or all of the important features (e.g., one or more functions) of a device being updated. In some implementations, the device tests whether operations are completed successfully, and optionally the device tests for performance characteristics also (e.g., throughput, latency, error rates, etc.). The criteria for determining that a device is operating properly or sufficiently well to permit higher trust can be based on not only completing operations or performing functions but on meeting predetermined performance standards also.

In stage (H), the terminal 150 receives a response message 184 from the server 120. The act of receiving the response message 184 in response to the request 182 demonstrates a successfully connection over a network, which indicates that the terminal 150 is operating properly with the updated software 170b in the partition P2 151b. The content of the response message 184 can include various features to show that it is an actual response to the request 182, such as providing values extracted from the request 182, providing a value generated based on the content of the request 182, etc. The terminal 150 examines the response message 184 and determines that the predetermined criteria for judging successful operation has been satisfied. In some implementations, the terminal permits an administrator or operator (whether local or remote) to verify operation and manually indicate the operation as successful. This option can be provided as an alternative route to confirming operation of updated software and configuration data.

In stage (I), the terminal 150 updates the trust parameters 154a to increase the the trust status 152b for the partition P2 151b based on the successful operation of the terminal 150 using the software 170b in the partition P2 151b. For example, because the criteria for successful operation are reached, the terminal 150 increases the trust status from “expired” to “permanent,” which will allow the terminal 150 to boot from the partition P2 151b in subsequent reboots or power cycles of the terminal 150. The resulting trust parameters 154a are “P2 main permanent; revert P1 factory.” This indicates that the partition P2 151b is used as the primary partition to be booted each time.

The example of FIGS. 1A-1D shows a process of updating and testing software by a device in the scenario where the software update is found to be successful. If the software update were unsuccessful, however, the terminal 150 is able to automatically recover from an error or incompatibility arising from installation of an update. For example, in FIG. 1C, after the terminal 150 has downloaded the new software 170b and marked the trust in the main partition P2 151b as “temporary,” the new software 170b is loaded but the trust is immediately marked as “expired,” thereby giving it only one shot to be loaded. In the event that the terminal 150 is unresponsive, not operational, or not functioning properly after the updated software 170b has been loaded, the communication with the server 120 would not be successful and trust would not be upgraded. The customer's typical response to an error or malfunction is to reboot (or power cycle) the terminal 150. Upon reboot, the terminal 150 would recognize that the trust in main partition P2 151b has “expired,” indicating that the stored version is not good, and therefore the terminal 150 loads the alternative version, which is the factory version v1 in this case.

In the example, the trust status for the main software has three different levels or values: (1) permanent, which indicates that the main software is good, and so rebooting the terminal 150 (any number of times) will cause this software to be loaded each time; (2) temporary, which indicates that the main software has not been verified to be good but can still be loaded with one or more limitations (e.g., it is permitted to be loaded once); and (3) expired, which indicates that the main software is not good or has failed, and so the terminal 150 must load an alternative version of the software, such as the factory software.

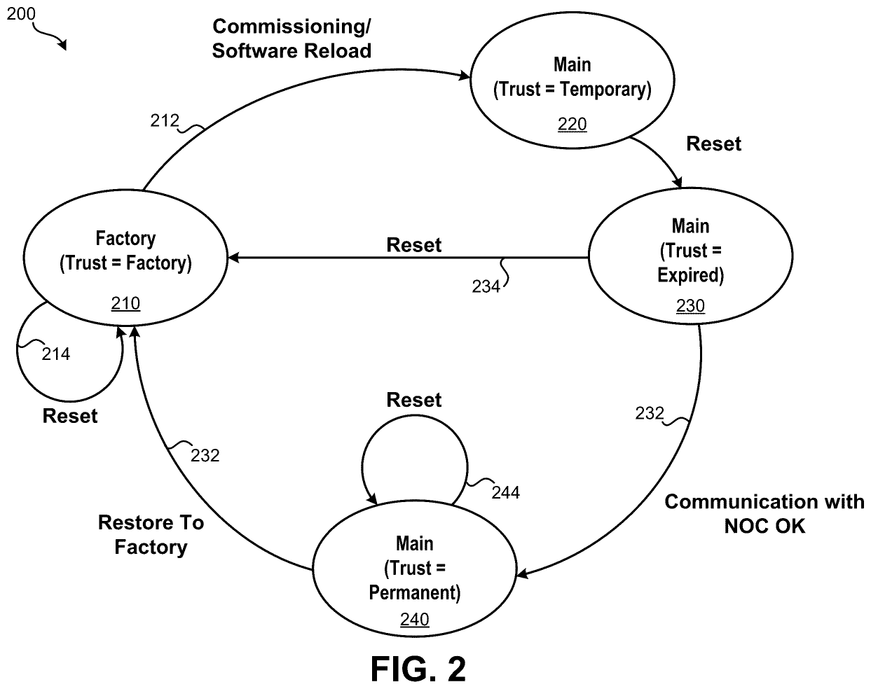

FIG. 2 is a state diagram showing an example of operations of a device for managing software versions and configurations. For example, FIG. 2 shows state transitions based on levels of trust of the main software (e.g., most recent or non-factory version) for a communication device.

In a first state 210, a device runs a factory version of software. When a software update is available, the device can download the updated software to a different partition, as part of commissioning or loading updated software for the device (212). This leads to the second state 220, in which the factory version is still running but the updated software is designated as the main version to use when next booting the device. The main version is assigned a low trust status (e.g., temporary trust) that corresponds to a limitation on use, such as the ability to boot the device only once without verifying proper operation. Loading the new software often includes a reset (e.g., reboot) of the device. In other words, the reset from state 220 to state 230 can be performed automatically by the device, as part of installing or adding the new software.

From the second state 220, resetting the device leads to a third state 230, in which the main version is running, but the allowable number of boots using the main software version has been expended, and so the trust status has been decreased from temporary to expired. In the third state 230, the device runs the main software version, but the “expired” trust status blocks use of the main software again after the device is reset. In the third state 230, the device, while running the updated software in the main partition, attempts to communicate with a network operations center (NOC).

If communication with the server 120 in the NOC is performed successfully (232), then the device moves to a fourth state 240, in which the upgraded software in the main (e.g., non-factory) partition is still designated to be used for booting the device, but the trust status has been increased to remove the previous limitation. For example, the “temporary” trust level has been replaced with a “permanent” trust level that allows unrestricted booting using the upgraded main version of the software. From the fourth state 240, a reset (244) (e.g., reboot or power cycle) of the device will cause the device to boot up again using the same main version of the software.

From the third state 230, if the communication with the NOC is not successful, then the trust status of the main software version is not elevated from the “expired” status. This indicates that the device did not operate properly with the main software version, and so the next time the device is reset (234), the device is returned to the first state 210, in which the factory version is run and the trust levels are set to use the factory version going forward. From the first state 210, if there is a reset (214) without having an additional updated version downloaded, the device will continue to run using the factory version.

In the example of FIG. 2, the trust level for the factory partition in state 210 is listed as “factory.” However, other status levels could be used or set. For example, in some implementations, the trust level can be set to “expired,” indicating that the device should attempt to download a new version, but by virtue of being a factory version (or being in a partition designated for the factory version), booting or loading of the software can be permitted to allow the acquisition of a new version.

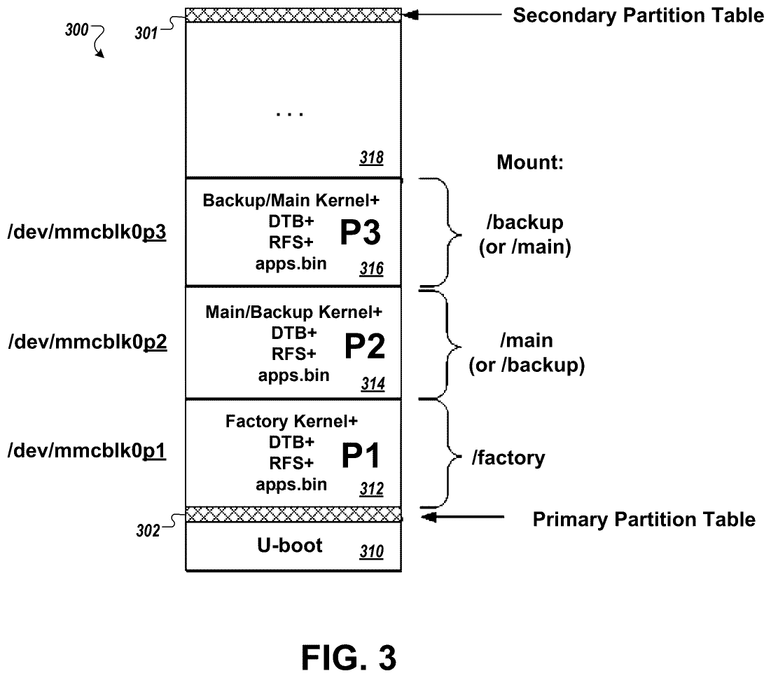

FIG. 3 is a diagram showing an example of a device storage partitions layout for managing software and configurations of a device. The example shows device storage 300 with a primary partition table 302 and a secondary partition table 301. The U-boot partition 310 hosts the device's Linux U-boot firmware along with U-boot environment variables including the information designating the boot priority and trust levels (e.g., a trust flag or other way to specify the trust parameters 154a) for the device.

The primary partition table 302 and the secondary partition table 301 describe storage areas for various partitions that can store software for the device. There are three partitions shown, a first partition P1 312, a second partition P2 314, and a third partition P3 316. Each partition can have a different identifier (e.g., /dev/mmcblk0p1 for the partition P1 312, /dev/mmcblk0p2 for partition P2 314, and /dev/mmcblk0p3 for partition P3 316).

n the example, each partition 312, 314, 316 can have a designated role in the or function, e.g., as the main version of the software (e.g., latest or current version), factory version (e.g., to be used when the device is recovered or reverted to factory settings), and backup version (e.g., a previous main version that operated properly). In the example, the partition P1 (listed as /dev/mmcblk0p1 and mounted as a factory partition “/factory”) contains the factory-shipped software. Once a software update is received, the updated version is stored in the partition P2 (listed as /dev/mmcblk0p2 and mounted as a main partition “/main”). Both the factory version in the partition P1 and the new main version in the partition P2 each include applications software (apps.bin) along with an operating system (e.g., Linux kernel), Device Tree Blob (DTB), and Root File System (RFS), and so on. Including the full set of software needed to run the device in each partition provides a way to easily switch between booting and using one partition rather than another. It also ensures that the set of software and configuration settings in any partition will represent a group of software and settings that is qualified and intended to work together.

If a further update is received (e.g., a second software update), the update can be loaded into the partition P3 316. This means that the partition P3 316 would become the new main version, and the software version in the partition P2 314 would be treated as a “backup,” e.g., the last-known good version, which is more up-to-date than the factory version. If the software in partition P3 316 fails to operate correctly after being downloaded, the new version is discarded and partition P2 314 becomes the main software version again.

If the software in partition P3 316 operates correctly, it remains the main version for the device until the next update (e.g., third update). At this point, the partition P2 314 (which is a backup at the time) can be overwritten with the newest version, and the partition P3 316 becomes the new backup. The device can subsequently alternate between storing new updates in the partition P2 314 and the partition P3 316, each time marking the current main partition as backup and downloading the new version as main to replace the old backup. In the event the trust is not set to permanent for the newly downloaded main version, the device can then revert to using the backup version instead of reverting to the much older factory version.

As an example of the trust flag:
trust=P2 main permanent; revert P1 factory
   This flag indicates to u-boot to load partition P2 as main and in case of errors, load partition P1 as factory.

As another example of the trust flag:
trust=P3 main temporary; revert P2 backup
   This flag indicates to u-boot to load partition P3 as main and in case of errors, load partition P2 as backup. U-boot loads P3 as main but immediately sets the trust as “expired” resulting in the flag to be updated as:
trust=P3 main expired; revert P2 backup
   Since the trust in main has expired, a power cycle or reboot of the device should now cause u-boot to load partition P2 as “backup”.

The trust settings ensure that the device is protected against unexpected power interruptions during and after software upgrades. Since the trust is not modified until the update is complete, the device restarts by booting in the existing partition if reset during the upgrade. On the other hand, if the device is reset post-upgrade before it establishes communication with the NOC/NMS, then the device cannot distinguish between a genuine power interruption versus a power cycle on part of the user to recover the device. In either case, the device reverts to the alternative partition and recovers automatically.

The trust settings can also be used to perform automatic updates to the factory version of the software. The main version's trust can also be used to determine if it can be used to update the outdated factory version, if needed. Typically, not every released main software version is qualified to be a factory version. Factory version replacements are typically provided only when the need arises. Hence, a special identifier such as “PID” can be added to the software version to indicate to the device that this release has been qualified to be installed as the factory version. The device also performs additional checks listed below before initiating a factory update:
Factory update is enabled (to give control to the NMS); and
The current (main) version is a “_PID” image (to make sure only qualified images are applied for the factory updates); and
The trust in current (main) is permanent (to make sure operational functionality has been verified); and
The current version has been operational for a predetermined period of time (to make sure the current main is operationally stable); and
No other “recovery” actions in progress (to make sure not to conflict with any other recovery processes).

If all of the above criteria are met, then the device automatically sets the trust to load the current partition (P2 or P3) as factory and reboots. For example, the trust can be set as:
trust=P2 factory permanent; revert P3 backup
   Upon reboot, based on the trust in this example, the device loads the software in partition P2 as the factory version. The device, as usual, contacts the server 120 in the NOC and NMS and downloads the (same) software and configuration.

The device recognizes that a factory version update is in progress based on the fact that the factory partition is not the typical partition P1. This determination leads the device to update the P1 partition 312 with the factory version. Upon successful update and reboot, the device reverts to the previous partition (e.g., partition P2 314 or the partition P3 316) as the main version, with the updated software in partition P1 312 designated as the factory version. At this point, the factory partition P1 312 is identical to the main partition P2 314, thereby completing the factory update.

If the automatic approach is not favored, the factory update can be triggered manually as well through an HTTP API. In the factory update process, the “trust” settings ensure that the device is protected against unexpected power interruptions either during or after the factory update. If interruption occurs, the device comes back in the same partition and starts over again.

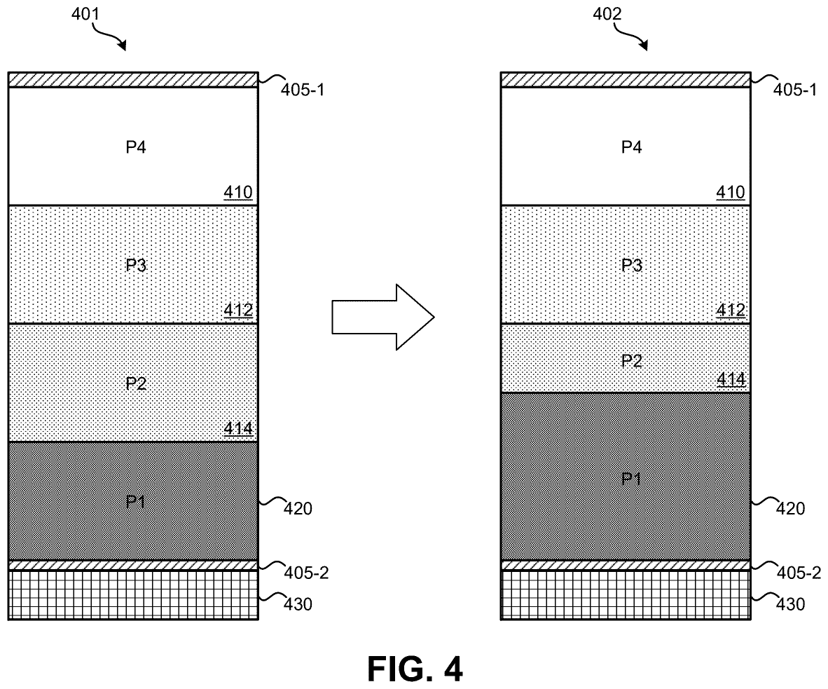

FIGS. 4-7B are focused on extending the factory update procedure to updating (trusted) software on a communication device (e.g., embedded device, satellite terminals, routers, gateways, IoT devices, etc.), in which repartitioning of a storage device on the communication device is necessary in order to store a larger future software update to the partition from which it will be executed. Such an update can involve installation of an entire operating system package (e.g., a board support package (BSP), which includes a kernel (e.g., Linux Kernel), root file system (RFS), and device tree binaries. Such a form of update may be referred to as a programmed item drawing (PID) update.

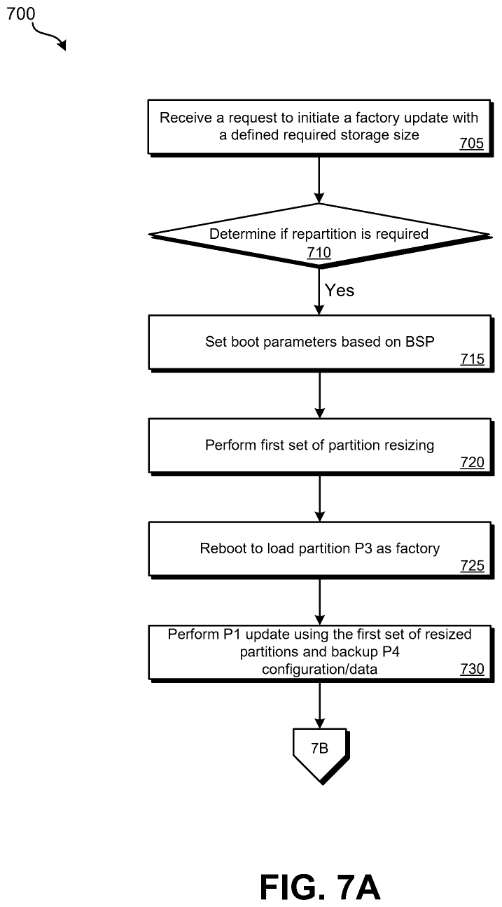

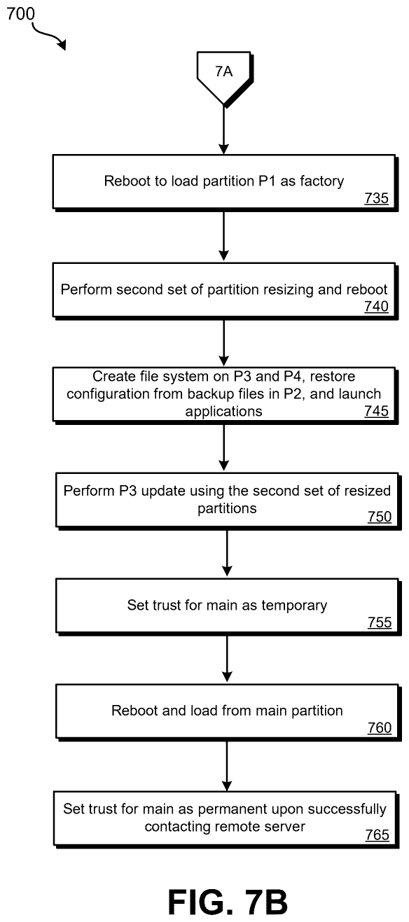

FIG. 4 illustrates an embodiment of adjustment of storage partitions of a communication device for which a software update is to be performed. The partitions, as illustrated in FIGS. 4-6, are not illustrated to scale. In concert with the descriptions of FIGS. 4-6, method 700 of FIGS. 7A and 7B is detailed. FIGS. 7A and 7B illustrate an embodiment of a method 700 for performing a software update involving a repartitioning of the storage device. FIG. 4 illustrates an embodiment of a partition configuration 401 of a storage device (e.g., hard disk drive, flash memory, EPROM, EEPROM, other forms of non-transitory processor-readable mediums capable of being rewritten to).

In partition configuration 401, partition P4 410, which can be referred to as a data storage partition, may store configuration data, logs, databases, etc., essential for the operation of the device. In this embodiment, partition P4 410 does not function as either a main, backup, or factory partition for booting to a kernel and applications stored on such partition. Partition P3 412, in the illustrated embodiment, stores an operating system package (which can include a kernel) and is designated as the main partition, i.e., partition hosting the current main software. Additional components may be stored to partition P3 412 with the kernel, such as device tree blob (DTB), root file system (RFS), and one or more pieces of application software. “Main” refers to the ‘latest and greatest’ software (containing all the new features and bug fixes) that is typically loaded upon system boot, assuming there are no errors. Partition P2 414, in the illustrated embodiment, stores an operating system package and is designated as the backup partition, i.e., partition hosting the current “backup” software. Additional components may also be stored to partition P2 414, such as a DTB, RFS, and application software. “Backup” refers to the software that would be loaded upon system boot, if an error prevents the main software from being loaded and functioning properly. Partition P1 420, in the illustrated embodiment, stores a kernel and is designated as the factory partition, i.e., partition hosting the factory software. Additional components may be stored to partition P1 420, such as a DTB, RFS, and application software.

“Factory” refers to the software that is typically installed at manufacture and is known with a very high degree of confidence to function properly. Hence, the factory partition may rarely be updated, since it is the last option in booting the device. If this software is required to boot but is non-functional, the device may no longer be functional until a technician can correct the issue in person. However, it may still be necessary to update a factory partition occasionally; over time, drivers and other components may be updated to such an extent that the factory operating system package on the factory partition is no longer compatible with other installed software versions. Therefore, while updated less frequently than other partitions, the designated factory partition may still be updated, nevertheless.

Additionally present in partition configuration 401 can be partition 430, which can be referred to as the boot partition, which can host firmware and environment variables, such as information designating boot partition priority and associated trust levels. A parameter can be stored to partition 430 that defines a trust level of the various main, backup, and factory partitions from which a boot can be performed. During normal operation, the main partition can be designated as permanent, with the backup and factory partitions serving as fallback options. If the main partition is designated as temporary, a boot to the main partition may be attempted once to see if it is successful in establishing communication with the remote server before converting it to permanent. If the temporary-designated partition fails, the backup or factory partitions may be loaded during the next reboot. In Linux-based systems, partition 430 can be referred to as a U-Boot partition. Partition tables 405, such as primary partition table 405-2 and secondary partition table 405-1, can be present.

At block 705, a request, such as in the form of an application programming interface (API) call, can be received from a remote server (e.g., via a satellite communication system or some other network-based communication arrangement). The request can be received by a communication device from a network management server located remotely from the communication device to which the update is to be applied. This request can define a parameter of required storage size, which, as the root file system partition size, is needed for a factory software update.

At block 710, a determination can be made as to whether the present partition size is sufficient for storage and installation of the operating system package. To make the determination of block 710, a manifest of the presently installed operating system package is checked. For example, in a BSP manifest, a parameter can be defined that indicates the present storage size used for the partitions, such as the present root file system. The BSP manifest for the factory partition can be analyzed to determine the present partition size; alternatively, an operating system query can be used for the determination. The factory update procedure previously detailed in this document is executed if the current partition size already meets the specified required storage size; repartitioning would be necessary otherwise.

One approach would be for the device to download and unpack the new software, examine the new software's BSP manifest, perform repartitioning if required, and install the new software. However, such an approach can cause multiple issues—resizing to increase P2 414 while currently executing out of P3 412 may encroach into the P3 412 partition itself and render the device non-functional. Resizing to increase P3 412 while executing out of P2 414 may encroach into the P4 410 partition and render the device non-functional due to loss of configuration. Resizing to increase factory partition P1 420 and installing new software into it while currently executing out of main partition P3 412 can be an option. However, updating the factory partition requires an operationally trusted software but the new software's trust can only be verified upon installing the new software. Hence, the method outlined in this embodiment uses the current operationally trusted main software image to update all the requisite partitions albeit with a larger partition size to facilitate future updates that require a larger partition size.

Block 710 involves comparing the present defined storage size with the required storage size of block 705. If the present size is sufficient, no repartitioning needs to be performed, and the factory update can proceed as previously detailed in this document. However, if the partition size needs to be increased and thus repartition is required, method 700 proceeds to block 715. In other embodiments, if the partition size is too big (e.g., by a threshold amount of storage space), method 700 can also be used to downsize the partitions used to store the operating system package. All the partitions that are to store the updated operating system package are resized to accommodate the larger storage requirement. For example, referring to partition configuration 401, repartitioning can be performed to increase the storage size of partitions P1 420 and P3 412, while a portion of partition P2 414 may be used as temporary storage for backing up configuration data. As an example, in a BSP manifest, the present RFS may be defined as: “platform_rfs_size: 400”; the request from the remote server can indicate “new_rfs_size: 600”. Since 600 MB is larger than 400 MB, repartitioning is necessary to increase the factory and main partitions by at least 200 MB each.

Prior to beginning an update in which repartitioning is performed, several confirmations may be made, including checking that the current trust level set for the main software is permanent, loaded from partition P3 412 and that the current main software has been operational for at least a predefined period of time. A further confirmation may be performed to ensure no other recovery action is in process. Assuming these conditions have been met, the update process of method 700 can continue.

At block 715, in response to the request of block 705 and determining that repartition is necessary at block 710, an update parameter can be set in the device's environment variables, such as in partition 430 (the boot partition) that indicates a storage space (e.g., RFS) resize procedure is in progress. Further, a second parameter may be defined indicating the size to which the partitions that will store the operating system packages should be resized.

At block 720, a first set of repartitioning operations are performed. A first partition may be redefined to be smaller, and a second partition to which the operation system package is to be installed may be redefined to be larger. Referring to FIG. 4, partition P2 414, which may be serving as the backup partition, may be repartitioned to be smaller, and partition P1 420, which serves as the factory partition, may be increased in size (either by the same amount which the other partition was downsized by or by a smaller amount). Referring to FIG. 4, following the repartitioning of block 720, partition configuration 402 may be present in which partition P1 420 is now large enough to accommodate the future operating system package. The increase in the size of partition P1 420 corresponds to being at least the defined size that is required, as indicated in the request received at block 705. This repartitioning process effectively erases the contents on the two resized partitions-as such, partitions P1 420 and P2 414 contain no software following repartitioning (and rebooting).

At block 725, the trust is set to load the current main software executing out of partition P3 412 to be loaded as factory at the next reboot:
trust=P3 factory
   Thus, at the next boot, only the current partition P3 412 will be available for booting, regardless, if any errors occur. In the example of FIG. 4, at block 725, partition P3 412 is the only partition having an installed operating system package, and applications, and thus is the current only option for booting. Following the trust setting, the communication device is rebooted at block 725. Upon reboot, software from partition P3 412 is loaded as factory. (While the smaller partition, such as partition P2 414, is not sufficient to store the new operating system package, it is intended to be used for temporary data storage, such as configuration files, etc. during the installation process.)

At block 730, the device, as usual, contacts the remote server in the NOC and NMS and downloads the (same) software and configuration via the satellite communication link. The device recognizes that a factory version update is in progress based on the fact that the current factory partition is not the typical factory partition P1 420. This determination leads the device to update partition P1 420 with the downloaded software (instead of P2 414). Furthermore, as part of block 730, a backup procedure can be performed to copy various configuration files, logs, databases, etc. (essential for restoring the device configuration) from another partition, such as partition P4 410 to partition P2 414. This backup procedure can involve creation of a filesystem (e.g., ext4) on partition P2 414. By moving essential or important data to partition P2 414, partition P4 410 can be resized and erased without losing data.

Method 700 continues on FIG. 7B. At block 735, now that the partition P1 420 is resized and loaded with the current trusted software, the trust parameter is set to load partition P1 420 as factory (effectively setting the trust in main as expired):
trust=P1 factory

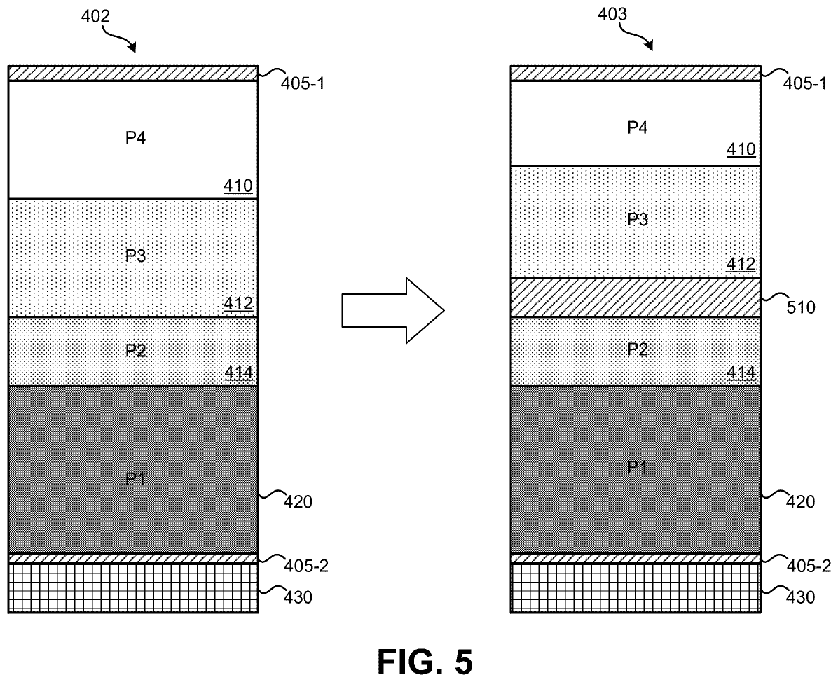

A reboot is then performed causing partition P1 420 to be loaded as factory. Based on the update parameter having been set on the boot partition at block 715, the communication device detects that a resizing update process is on-going. In response, at block 740, a second set of partition resizing operations are performed. An additional partition is decreased in size and another partition is increased in size to accommodate the required size indicated by the request of block 705. FIG. 5 illustrates an embodiment of further adjustment of the storage partitions of the communication device for which the software update is to be performed. FIG. 5 illustrates the transition from partition configuration 402 to partition configuration 403. These further adjustments can correspond to the operations of block 740. As shown in FIG. 5, partition P4 410 may be decreased in size and partition P3 412 can be relocated and increased in size. (Space 510 represents a gap that can be used subsequently to increase the size of the partition P2 414.)

As part of block 740, the update parameter can be updated to a new value that is indicative of a second stage of the update process needing to be performed. Therefore, the update parameter may be able to reflect at least three states, such as 0 for no update in progress, 1 for a first stage of the update process, 2 for a second stage of the update process. Once the parameter has been set to be indicative of the second stage, a reboot may be performed as part of block 740. Following the reboot, no data and software may be available in the newly defined partitions for partitions P4 410 and P3 412, respectively. Following the reboot, a check may be performed to ensure that the sizes of the resized partitions, partitions P4 410 and P3 412, are as expected. Following the reboot, based on the trust parameter that defines partition P1 420 as factory, partition P1 420 is loaded as factory. Based on the parameter set to be indicative of the second stage, as part of block 745, a filesystem, is established on partition P4 410 and is mounted. The backup files previously stored to partition P2 414 at block 730 can be copied back to partition P4 410. With all of the backup files now recovered from partition P2 414, partition P2 414 can be unmounted and resized to incorporate some or all of space 510. Partition P2 414 can be resized to be able to accommodate the operating system package. Further, as part of block 745, the update parameter can be modified to indicate that the resizing process is now complete. In some embodiments, the second parameter indicative of size is also cleared (e.g., to zero).

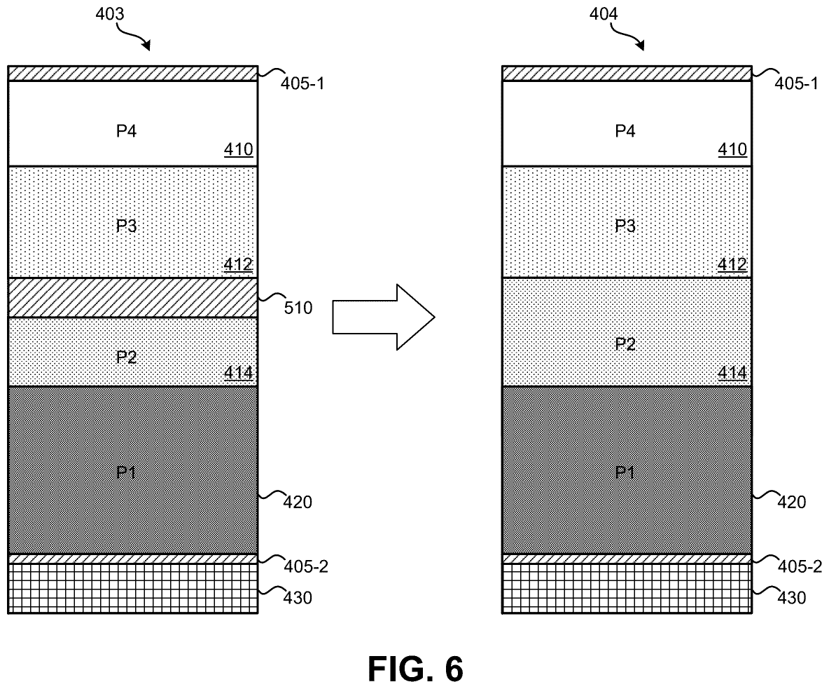

FIG. 6 illustrates an embodiment of further adjustment to the storage partitions of the communication device for which the software update is being performed. FIG. 6 illustrates the transition from partition configuration 403 to the final partition configuration 404. These further adjustments can correspond to the operations of block 745. As shown in FIG. 6, partition P2 414 is increased in size to include space 510.

As part of block 745, one or more applications in partition P1 420 can be launched. Following these applications being launched, as part of block 750, the device contacts the remote server and downloads the (same) software again to partition P3 412. (This, effectively, is the typical installation process of factory software version executing out of the partition P1 420 downloading main version into the partition P3 412.)

Once downloaded, at block 755, the partition to which the operating system package is downloaded at block 750 (e.g., partition P3 412) is defined as “main” via the trust parameter stored to partition 430. The trust parameter includes an indication that trust in main is temporary and that reversion to partition P1 420 is to be performed if a reboot to partition P3 412 fails or the communication device is rebooted due to failure to communicate with the remote server.
trust=P3 main temporary; revert P1 factory

At block 760, a reboot is performed and, based on the trust parameter, partition P3 412 is loaded as main, and its trust is immediately set to expired. If communication is successfully established with the remote server, the trust parameter is again updated to redefine the trust for the main partition from expired to permanent at block 765.
trust=P3 main permanent; revert P1 factory

In the event the device is rebooted as a result of being unable to contact the remote server post update, the device reverts to the software from partition P1 420 as factory. Therefore, following blocks 760 and 765, partition P1 420 is used as the factory partition and partition P3 412 is used as the main partition in a permanent capacity. Partition P2 414 can remain unused for now but can be used to store the next software update (presumably with the larger root file system) that is to be installed at some point in the future with the resized partition P2 414 likely being sufficient in size. When such an installation is performed, partition P3 412 can serve as new backup and partition P2 414 as the new main. Following block 760, the device can execute its installed one or more applications normally and can continue to do as such until the next update is necessary.

It should be noted that with the combination of operational trust and other boot parameters, the device is able to recover and resume the procedure at any stage in the event of an unexpected reboot.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves, and many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the scope of the claims.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the scope of the claims. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for performing a software update, the method comprising:
receiving, by a communication device, from a remote server system, a request to initiate a software update, wherein the request indicates a required amount of storage space for an operating system, wherein:
a plurality of partitions are defined on a storage device of the communication device, the plurality of partitions comprising at least a first partition, a second partition, a third partition, and a fourth partition;
determining, by the communication device, that the first partition of the storage device is insufficient in size based on the required amount of storage space indicated in the request;
in response to determining that the first partition of the storage device is insufficient in size, decreasing the size of the second partition and increasing the size of the first partition;
redefining the third partition as a factory partition such that only the third partition is trusted and available for booting;
after redefining the third partition as the factory partition, downloading, by the communication device, from the remote server system, the software update to the first partition; and
after downloading the software update, redefining the first partition as the factory partition such that only the first partition is trusted and available for booting.

2. The method for performing the software update of claim 1, further comprising:
after redefining the first partition as the factory partition, decreasing the size of the fourth partition and increasing the size of the third partition; and
downloading, by the communication device, from the remote server system, the software update to the third partition.

3. The method for performing the software update of claim 2, further comprising:
prior to decreasing the size of the fourth partition, copying data from the fourth partition to the second partition; and
after decreasing the size of the fourth partition, copying the data from the second partition to the fourth partition.

4. The method for performing the software update of claim 3, further comprising:
after downloading the software update to the third partition, redefining a boot trust parameter for the communication device to define a temporary level of trust for booting to the third partition and defining factory in the first partition to serve as a backup for booting if booting to the third partition fails or the communication device is rebooted due to failure to communicate with the remote server.

5. The method for performing the software update of claim 4, further comprising:
after redefining the boot trust parameter for the communication device to define a temporary level of trust for booting to the third partition, rebooting the communication device; and
in response to booting and communicating with the remote server successfully, redefining the boot trust parameter for the communication device to define a permanent level of trust for booting to the third partition.

6. The method for performing the software update of claim 1, wherein the communication device communicates with the remote server system via satellite.

7. The method for performing the software update of claim 1, wherein:
when determining whether the first partition of the storage device is at least as large as the required amount of storage space, the first partition is defined as the factory partition; and
when redefining the third partition as the factory partition, such that only the third partition is available for booting, the first partition is no longer defined as the factory partition.

8. The method for performing the software update of claim 1, wherein determining that the first partition of the storage device is at least as large as the required amount of storage space comprises analyzing a board support package (BSP) manifest.

9. A communication device, comprising:
one or more processors; and
one or more machine-readable media storing instructions that are operable, when executed by the one or more processors, to cause the communication device to perform operations comprising:
receiving, from a remote server system, a request to initiate a software update, wherein the request indicates a required amount of storage space for an operating system, wherein:
a plurality of partitions are defined on a storage device of the communication device, the plurality of partitions comprising at least a first partition, a second partition, a third partition, and a fourth partition;
determining that the first partition of the storage device is insufficient in size based on the required amount of storage space indicated in the request;
in response to determining that the first partition of the storage device is insufficient in size, decreasing the size of the second partition and increasing the size of the first partition;
redefining the third partition as a factory partition such that only the third partition is trusted and available for booting;
after redefining the third partition as the factory partition, downloading, from the remote server system, the software update to the first partition; and
after downloading the software update, redefining the first partition as the factory partition such that only the first partition is trusted and available for booting.

10. The communication device of claim 9, wherein the machine-readable media storing instructions further cause the communication device to perform operations comprising:
after redefining the first partition as the factory partition, decreasing the size of the fourth partition and increasing the size of the third partition; and
downloading, from the remote server system, the software update to the third partition.

11. The communication device of claim 10, wherein the machine-readable media storing instructions further cause the communication device to perform operations comprising:
prior to decreasing the size of the fourth partition, copying data from the fourth partition to the second partition; and
after decreasing the size of the fourth partition, copying the data from the second partition to the fourth partition.

12. The communication device of claim 11, wherein the machine-readable media storing instructions further cause the communication device to perform operations comprising:
after downloading the software update to the third partition, redefining a boot trust parameter for the communication device to define a temporary level of trust for booting to the third partition and defining factory in the first partition to serve as a backup for booting if booting to the third partition fails or the communication device is rebooted due to failure to communicate with the remote server.

13. The communication device of claim 12, wherein the machine-readable media storing instructions further cause the communication device to perform operations comprising:
after redefining the boot trust parameter for the communication device to define a temporary level of trust for booting to the third partition, rebooting the communication device; and
in response to booting and communicating with the remote server successfully, redefining the boot trust parameter for the communication device to define a permanent level of trust for booting to the third partition.

14. The communication device of claim 9, wherein the communication device communicates with the remote server system via satellite.

15. The communication device of claim 9, wherein:
determining whether the first partition of the storage device is at least as large as the required amount of storage space, the first partition is defined as the factory partition; and
redefining the third partition as the factory partition, such that only the third partition is available for booting, the first partition is no longer defined as the factory partition.

16. The communication device of claim 9, wherein determining that the first partition of the storage device is at least as large as the required amount of storage space comprises analyzing a board support package (BSP) manifest.

17. A non-transitory processor-readable medium comprising processor-readable instructions configured to cause one or more processors of a communication device to:
receive a request to initiate a software update, wherein the request indicates a required amount of storage space for an operating system, wherein:
a plurality of partitions are defined on a storage device of the communication device, the plurality of partitions comprising at least a first partition, a second partition, a third partition, and a fourth partition;
determine that the first partition of the storage device is insufficient in size based on the required amount of storage space indicated in the request;
in response to determining that the first partition of the storage device is insufficient in size, decrease the size of the second partition and increasing the size of the first partition;
redefine the third partition as a factory partition such that only the third partition is trusted and available for booting;
after redefining the third partition as the factory partition, download from a remote server system the software update to the first partition; and
after downloading the software update, redefine the first partition as the factory partition such that only the first partition is trusted and available for booting.

18. The non-transitory processor-readable medium of claim 17, wherein the machine-readable media storing instructions further cause the one or more processors to:
after redefining the first partition as the factory partition, decrease the size of the fourth partition and increasing the size of the third partition; and
downloading, from the remote server system, the software update to the third partition.

19. The non-transitory processor-readable medium of claim 18, wherein the machine-readable media storing instructions further cause the one or more processors to:
prior to decreasing the size of the fourth partition, copy data from the fourth partition to the second partition; and
after decreasing the size of the fourth partition, copy the data from the second partition to the fourth partition.

20. The non-transitory processor-readable medium of claim 19, wherein the machine-readable media storing instructions further cause the one or more processors to:
after downloading the software update to the third partition, redefine a boot trust parameter for the communication device to define a temporary level of trust for booting to the third partition and defining factory in the first partition to serve as a backup for booting if booting to the third partition fails or the communication device fails to communicate with the remote server.
